(19) United States
(12) Patent Application Publication
(10) Pub. No.: US 2018/0290055 A1
(43) Pub. Date: Oct. 11, 2018

(54) RHYTHM GAME DISPLAYING METHOD AND TERMINAL FOR PERFORMING THE METHOD

(71) Applicant: Next Floor Corp., Seoul (KR)

(72) Inventor: Young Soo Kim, Seoul (KR)

(21) Appl. No.: 15/628,492

(22) Filed: Jun. 20, 2017

(30) Foreign Application Priority Data
Apr. 7, 2017 (KR) 10-2017-0045505

(51) Int. Cl. A63F 13/426; A63F 13/814

(52) U.S. Cl. CPC A63F 13/426; A63F 13/814

(57) ABSTRACT

A rhythm game displaying method is performed by a terminal including a touch screen display. The method includes: rendering and displaying a virtual three-dimensional space on the touch screen display, the virtual three-dimensional space provided with an axis making an angle of 0 degree or more with respect to an image plane of the touch screen display and positioned in a first space opposite to a user with respect to the image plane; rendering one or more rhythm notes having predetermined moving routes at least partially parallel to the axis in the virtual three-dimensional space and displaying the rhythm notes on the touch screen display, wherein each of the rhythm notes configured to appear at one end of each of the moving routes, move along each of the moving routes and pass through each of hit reference positions existing on the moving routes; rendering the hit reference positions and displaying the hit reference positions on the touch screen display; receiving an input from the user at positions on the touch screen display corresponding to the hit reference positions; and determining the accuracy of a user input based on a difference between a timing at which a rhythm note passes through a hit reference position and the timing at which the input is received from the user.

### TECHNICAL FIELD

The present disclosure relates to a rhythm game displaying method and, more particularly, to a method of displaying a rhythm game on a terminal using a virtual three-dimensional space as a background.

### BACKGROUND

Many rhythm games of a type in which an input is performed when a rhythm note moving in conformity with music reaches a hit reference position have been commercially available since the late 90s. Also, in recent years, various smart devices using a touch screen have appeared, and many rhythm games using a touch screen input method also have become commercially available.

As conventional games, for example, the game “Music & Beat” of O2Jam Corporation shown in FIG. 10A or the game “EQLIPSE” produced by students of Kyushu University of Japan shown in FIG. 10B is a typical example of a rhythm game in which the score is calculated when a user performs an input when a rhythm note moving up or down on the screen reaches a hit reference position located in a predetermined space at the upper end or lower end of the screen. In both games mentioned above, the rhythm note is displayed such that the rhythm note becomes larger as it comes closer to the user's side. Thus, the user may feel a little sense of space. However, since the space of the game itself does not have any dynamically moving element, there is a limit to the user's sense of space. In addition, since the heat reference position exists only in a fixed area, it is difficult for a user to enjoy a dynamic game.

According to the game “Rhythm & Joy” of Nexon Co., Ltd. shown in FIG. 10C, a hit reference position is created at a random location on a game screen, and a rhythm note appears at a position far from the user. The user may perform an input when the rhythm note reaches the hit reference position. The background of this game (the scene where a character is dancing) may be recognized as a three-dimensional space. The viewpoint of this background is also changed continuously. However, the rhythm note or the hit reference position is not linked with the three-dimensional background. Thus, it is difficult for the user to feel a great sense of space while playing the game.

As described above, devices for enabling a user to feel a sense of space are also included in the conventional rhythm games. However, devices for enabling a user to feel a sense of space have limitations as mentioned above. The present disclosure provides a rhythm game displaying method in which, in response to a dynamic movement of a three-dimensional space serving as a background of a rhythm game, a rhythm note or a hit reference position can move in conjunction with the three-dimensional space.

### SUMMARY

According to one embodiment of the present disclosure, there is provided a rhythm game displaying method performed by a terminal including a touch screen display, including: rendering and displaying a virtual three-dimensional space on the touch screen display, the virtual three-dimensional space provided with an axis making an angle of 0 degree or more with respect to an image plane of the touch screen display and positioned in a first space opposite to a user with respect to the image plane; rendering one or more rhythm notes having predetermined moving routes at least partially parallel to the axis in the virtual three-dimensional space and displaying the rhythm notes on the touch screen display, wherein each of the rhythm notes configured to appear at one end of each of the moving routes, move along each of the moving routes and pass through each of hit reference positions existing on the moving routes; rendering the hit reference positions and displaying the hit reference positions on the touch screen display; receiving an input from the user at positions on the touch screen display corresponding to the hit reference positions; and determining the accuracy of a user input based on the difference between the timing at which a rhythm note passes through a hit reference positions and the timing at which the input is received from the user, wherein the moving routes are fixed in the virtual three-dimensional space, the virtual three-dimensional space is rendered so that the virtual three-dimensional space moves with respect to the image plane according to a predetermined method during at least a part of a time period when the rhythm game is ongoing and so that the moving routes fixed in the virtual three-dimensional space also move together with the movement of the virtual three-dimensional space, and the hit reference positions are located at any position within a range in which the virtual three-dimensional space is displayed.

In the method, the hit reference positions may move on the moving routes.

The method may further include: rendering the predetermined moving routes and displaying the predetermined moving routes on the touch screen display.

The method may further include: displaying the predetermined moving routes on the touch screen display after the rhythm notes appear in the first space.

In the method, the axis may be substantially perpendicular to the image plane.

In the method, the axis may be a straight line or a curved line.

In the method, the axis may have a shape which changes over time.

In the method, the virtual three-dimensional space may have a cylindrical or polygonal columnar shape, the axis may correspond to a center axis of the cylinder or the polygonal column shape, and the rendering and displaying the virtual three-dimensional space on the touch screen display may include displaying at least a part of a side wall of the virtual three-dimensional space on the touch screen display.

The method may further include: displaying a determination result obtained in the determining the accuracy of the user input on the touch screen display.

In the method, the movement of the virtual three-dimensional space with respect to the image plane according to the predetermined method may include a rotational movement of the virtual three-dimensional space about the axis or a parallel movement of the axis.

In the method, the movement of the virtual three-dimensional space with respect to the image plane according to the predetermined method may include at least one of a movement of the virtual three-dimensional space toward a specific end of the axis, a conical movement of a first end of the axis about an arbitrary fixed point on the axis performed so as to draw a circle, a movement of a user side end of the axis from the inside of the image plane toward the outside of the image plane, a movement of the user side end of the axis from the outside of the image plane toward the inside of the image plane, a change of a shape of the axis, and a change of a size of the virtual three-dimensional space.

In the method, the rhythm notes may be configured to change movement directions thereof at least once when moving along the moving routes.

In the method, the axis may have a first end oriented toward the user and a second end oriented toward the first space.

In the method, the movement of the virtual three-dimensional space may be determined based on the determination result obtained in the determining the accuracy of the user input or the input received from the user, and the virtual three-dimensional space moves according to the movement of the virtual three-dimensional space thus determined.

The method may further include: displaying position indicators, which advise the user of positions of the rhythm notes in the virtual three-dimensional space, on the virtual three-dimensional space.

In the method, the side wall displayed on the touch screen display may be rendered so that, during a part of a time period when the rhythm game is ongoing, the side wall is moved according to a predetermined method in a state in which the moving routes are not fixed in the virtual three-dimensional space.

In the method, the movement of the side wall according to the predetermined method in a state in which the moving routes are not fixed in the virtual three-dimensional space may include a change of a size of the virtual three-dimensional space.

According to another embodiment of the present disclosure, there is provided a rhythm game displaying method performed by a terminal including a touch screen display, including: rendering and displaying a virtual three-dimensional space on the touch screen display, the virtual three-dimensional space provided with an axis making an angle of 0 degree or more with respect to an image plane of the touch screen display and positioned in a first space opposite to a user with respect to the image plane; rendering one or more rhythm notes having predetermined moving routes at least partially parallel to the axis in the virtual three-dimensional space and displaying the rhythm notes on the touch screen display, wherein each of the rhythm notes is configured to appear at one end of each of the moving routes, move along each of the moving routes and pass through each of hit reference positions existing on the moving routes, the moving routes fixed in the virtual three-dimensional space; rendering the hit reference positions and displaying the hit reference positions on the touch screen display; receiving an input from the user at positions on the touch screen display corresponding to the hit reference positions; determining the accuracy of the user input based on the difference between the timing at which a rhythm note passes through each of the hit reference position and the timing at which the input is received from the user; and rendering the virtual three-dimensional space so that the virtual three-dimensional space moves with respect to the image plane based on the determination result obtained in the determining the accuracy of the user input or the input received from the user and so that the moving routes fixed in the virtual three-dimensional space also move together with the movement of the virtual three-dimensional space, wherein the hit reference positions are located at any position within a range in which the virtual three-dimensional space is displayed.

In the method, the virtual three-dimensional space may be rendered so that the virtual three-dimensional space further moves with respect to the image plane according to a predetermined method during at least a part of a time period when the rhythm game is ongoing and so that the moving routes fixed in the virtual three-dimensional space also move together with the movement of the virtual three-dimensional space.

In the method, a side wall of the virtual three-dimensional space displayed on the touch screen display may be rendered so that, during a part of a time period when the rhythm game is ongoing, the side wall moves according to a predetermined method in a state in which the moving routes are not fixed in the virtual three-dimensional space.

In the method, the movement of the side wall according to the predetermined method in a state in which the moving routes are not fixed in the virtual three-dimensional space may include a change of a size of the virtual three-dimensional space.

According to a further embodiment of the present disclosure, there is provided a terminal including a touch screen display, including: a control unit configured to control the touch screen display and configured to control an operation of the terminal, wherein the control unit is configured to execute the foregoing methods.

According to a still further embodiment of the present disclosure, there is provided a computer program stored in a computer-readable recording medium so as to cause a computer to execute the foregoing methods.

According to a yet still further embodiment of the present disclosure, there is provided a computer-readable recording medium which stores a computer program configured to execute the foregoing methods.

According to the present disclosure, in response to a dynamic movement of a three-dimensional space serving as a background of a rhythm game, rhythm notes or hit reference positions moves in conjunction with the three-dimensional space. Thus, a user has to make a play while estimating the three-dimensional movement of the rhythm notes based on the movement of the three-dimensional space. This makes it possible to provide a user with a higher sense of space.

Furthermore, the entirety of a touch screen display screen serves as an input unit of a rhythm game. This enables a user to make multifarious plays.

In addition, through the use of the configuration in which the movement of the three-dimensional space is determined according to the timing determination result of the rhythm notes or the user input, it is possible to make sure that the entire space of a game is moved in response to a user's play. This makes it possible to provide a user with experiences and fun different from those of the conventional games.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a configuration diagram showing a user terminal 100 for realizing an embodiment of the present disclosure.

FIG. 2 is a view showing an example of a game screen which displays a rhythm game according to one embodiment of the present disclosure.

FIGS. 3A to 3D are views showing different forms of a virtual three-dimensional space according to one embodiment of the present disclosure.

FIG. 4 is a view showing one example of a game screen for displaying a rhythm game according to one embodiment of the present disclosure.

FIGS. 5A to 5D are views showing the movements of a virtual three-dimensional space according to one embodiment of the present disclosure.

FIGS. 6A to 6D are views showing the movements of a virtual three-dimensional space according to one embodiment of the present disclosure.

FIG. 7 is a view showing one example of a game screen for displaying a rhythm game according to one embodiment of the present disclosure.

FIG. 8 is a view showing an actual game screen for displaying a rhythm game according to one embodiment of the present disclosure.

FIG. 9 is a flowchart showing a rhythm game displaying method according to one embodiment of the present disclosure.

FIGS. 10A to 10C are views showing conventional rhythm game screens.

### DETAILED DESCRIPTION

An embodiment of the present disclosure will now be described in detail with reference to the accompanying drawings. The configuration of an embodiment of the present disclosure and the operation and effect thereof will be clearly understood from the following description.

Prior to describing the present disclosure in detail, it is to be noted that description of well-known configurations may be omitted since features of such configurations are well-known.

Hereinafter, a method according to an embodiment of the present disclosure will be described with reference to the drawings. It should be noted that the configuration and method according to an embodiment of the present disclosure are not limited to the contents to be described below, and the present disclosure may be applied to various embodiments based on the following embodiments. In the following description, the present disclosure will be described by taking a hardware-based approach as an example. However, the present disclosure includes a technique that makes use of both hardware and software. Thus, the present disclosure does not exclude a software-based approach.

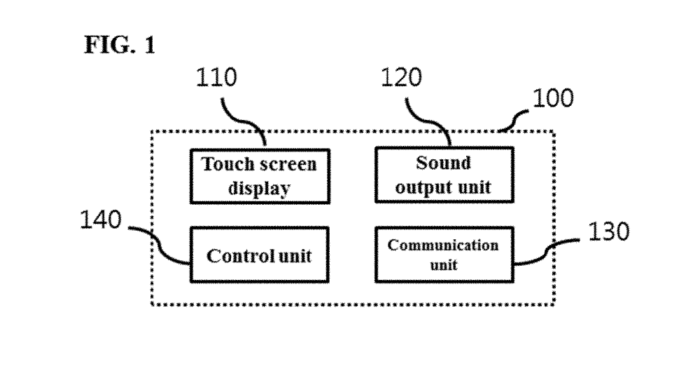

As shown in FIG. 1, the rhythm game displaying method according to the present disclosure includes a user terminal 100.

The user terminal 100 refers to a terminal used for a rhythm game displaying method. In the present embodiment, the user terminal 100 is, for example, an electronic device including a touch screen display, such as a smartphone, a cellular phone, a PDA (Personal Digital Assistant), a tablet PC, a notebook PC or the like. As shown in FIG. 1, the user terminal 100 includes, but is not limited to, a touch screen display 110, a sound output unit 120, a communication unit 130 and a control unit 140. These components are not limited to the forms shown in FIG. 1 but may have any form as long as they can perform the processes which will be described later.

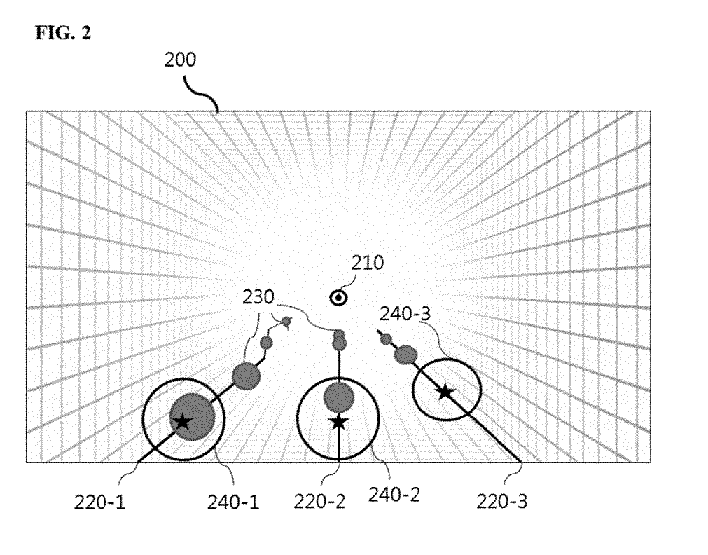

The touch screen display 110 is a combination of a touch screen for receiving a touch input from a user and a display device for displaying contents to be shown to a user, such as a liquid crystal display (LCD), an organic light emitting diode (OLED), an active matrix organic light emitting diode (AMOLED) or the like. The touch screen display 110 is well-known in the art and, therefore, will not be described in detail herein. The sound output unit 120 is configured to output a sound from the user terminal 100 and may output a sound via not only a speaker (not shown) mounted on the user terminal 100 but also an external output device such as an earphone, a headphone or the like which is connected to the user terminal 100 in a wire or wireless manner. The communication unit 130 is connected to a network so as to make communication. The control unit 140 has a function of controlling a signal flow between the touch screen display 110, the sound output unit 120, the communication unit 130 and other components (not shown) of the user terminal 100, and controlling the operations of the components of the user terminal 100. The control unit 140 includes, but is not limited to, a main memory device configured to store applications, data associated with the applications and an operating system, a cache memory configured to temporarily store data, a graphics processing unit (GPU) configured to govern a three-dimensional rendering work, and/or a central processing unit (CPU) configured to perform a function of controlling the overall operation of the terminal so as to execute the rhythm game displaying method to be described later with reference to FIGS. 2 to 9 and a function of processing three-dimensional rendering in a software manner.

FIGS. 2 to 8 are views for explaining one example of a game screen for displaying a rhythm game in one embodiment of the present disclosure. FIG. 2 is a view showing an example of a game screen according to one embodiment of the present disclosure. First, a virtual three-dimensional space 200 is rendered and displayed on a display.

As used herein, the expression “rendered and displayed” means that an object of a virtual three-dimensional space is converted to a two-dimensional image from a viewpoint of a virtual camera. A software graphic engine or a hardware graphic engine may be used in order to realize three-dimensional rendering. The game may be realized by rendering the aforementioned two-dimensional image in real time and displaying the two-dimensional image as a moving image. In one embodiment, in order to generate a three-dimensional space, each of the objects to be displayed may be modeled as a plurality of polygons each having many graphic attributes such as texture, transparency, lighting, shading, anti-aliasing or the like. In the subject specification, in addition to the virtual three-dimensional space 200, an axis 210 of a three-dimensional space, a moving route 220, a rhythm note 230, a hit reference position 240, a position indicator 250 and the like, which will be described in detail later, may be rendered and displayed on the display. However, the present disclosure is not limited thereto. The three-dimensional rendering technique used in the present disclosure is well-known in the art and, therefore, will not be described in detail herein.

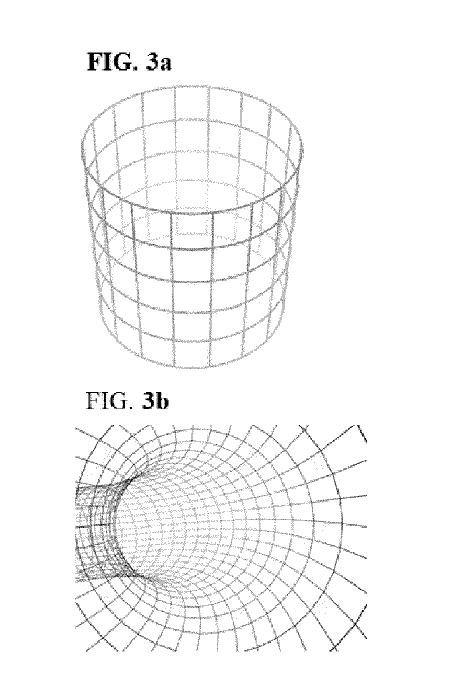

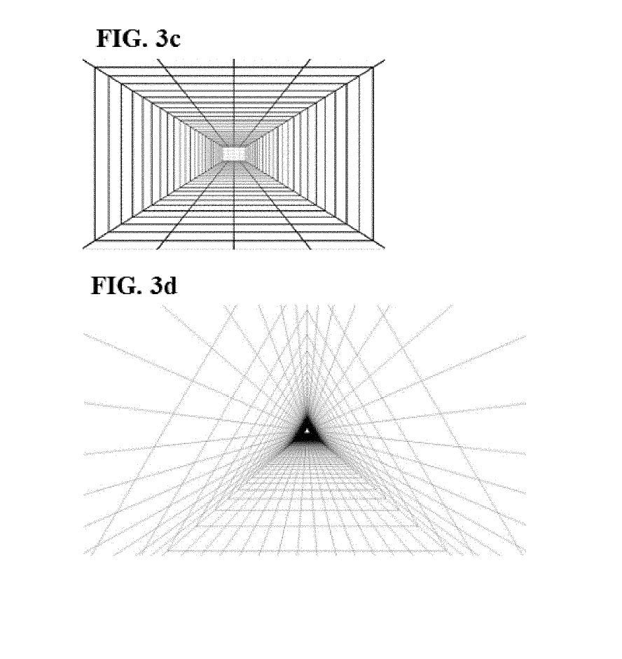

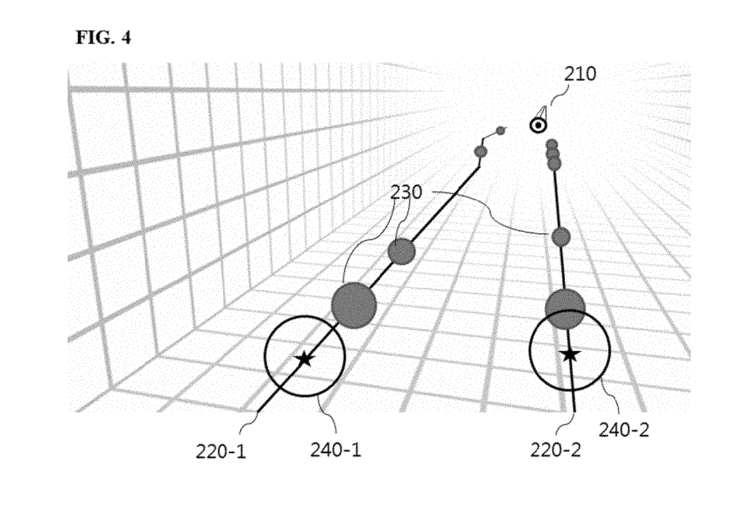

A virtual three-dimensional space 200 having a rectangular columnar shape exists in a space opposite to a user with respect to the image plane of the display. In the present embodiment, the virtual three-dimensional space 200 has a rectangular columnar shape. However, the virtual three-dimensional space 200 may have, for example, a cylindrical shape or a polygonal columnar shape or the like as shown in FIGS. 3A to 3D. However, the present disclosure is not limited thereto. The virtual three-dimensional space 200 may have any arbitrary shape capable of giving a sense of cube to a user. In the present embodiment, all the side walls of the virtual three-dimensional space are displayed. In another embodiment, only a part of the side walls of the virtual three-dimensional space may be displayed. In an embodiment in which only a part of side walls of a polygonal column is displayed, for example, in an embodiment shown in FIG. 2, the left and right side walls are represented as empty spaces, and only the upper and lower side walls are be displayed. In another embodiment in which only a part of side walls of a polygonal column is displayed, for example, in an embodiment shown in FIG. 2, the upper and lower side walls are represented as empty spaces, and only the left and right side walls are displayed. In this case, the left and right side walls are displayed in a large size so that the distal ends of the left and right side walls are not displayed on the screen. This enables a user to feel as if infinitely-expanding planes are displayed. The axis 210 of the virtual three-dimensional space refers to an axis passing through the center of the virtual three-dimensional space. In the embodiment shown in FIG. 2, the axis passing through the center of the rectangular column is the axis 210 of the virtual three-dimensional space. Furthermore, in the present embodiment, the axis 210 of the virtual three-dimensional space is a straight line. However, the axis 210 of the virtual three-dimensional space may be a curved line as shown in FIG. 3B. The axis 210 of the virtual three-dimensional space may be disposed perpendicularly to the image plane of the display or may be disposed at a predetermined angle with respect to the image plane as shown in FIG. 4. The axis 210 may not be displayed on the screen or may be displayed in another embodiment.

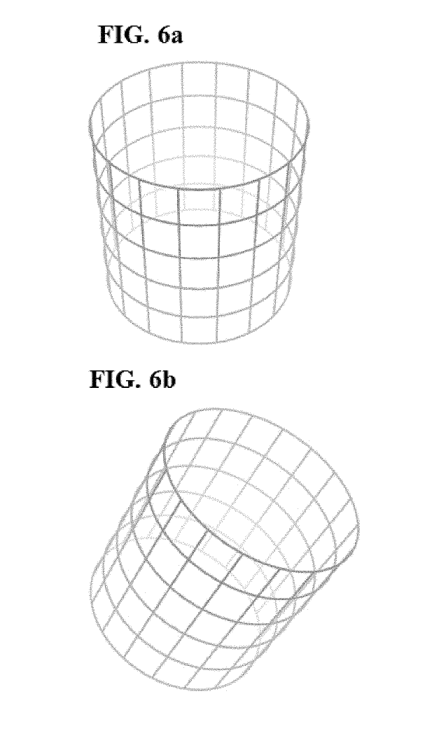

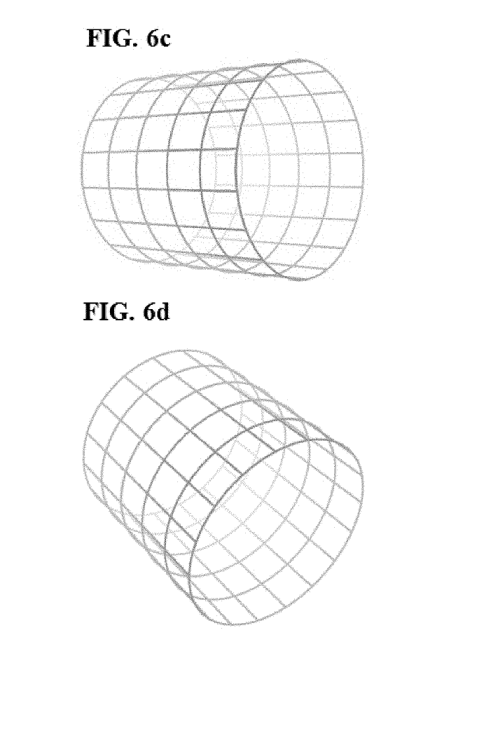

In the embodiment shown in FIG. 2, the axis 210 of the virtual three-dimensional space extends substantially perpendicularly from the center of the image plane toward a user. In another embodiment, the axis 210 makes a specific angle of 0 degree or more with respect to the image plane. The axis 210 makes an angle of 0 degree with respect to the image plane when the axis 210 is parallel to the image plane. The axis 210 makes an angle of 90 degrees with respect to the image plane when the axis 210 is disposed as in the embodiment shown in FIG. 2. FIGS. 3B and 3D show a case where one end portion of the axis 210 exists within the image plane. In this embodiment, a user feels as if the user looks at a three-dimensional tunnel inside the tunnel. FIG. 3A and FIGS. 6A to 6D show a case where one end portion of the axis 210 exists outside the image plane. In this embodiment, a user feels as if the user looks at a three-dimensional tunnel outside the tunnel.

The rhythm notes 230 shown in FIG. 2 appear at one end of predetermined moving routes 220-1, 220-2 and 220-3 existing at fixed positions inside the three-dimensional space 200 and move along the moving routes. The rhythm notes 230 are rendered and displayed so as to pass through hit reference positions 240-1, 240-2 and 240-3 existing on the moving routes. In one embodiment, the moving direction of the rhythm notes 230 is not changed. In another embodiment, the moving direction of the rhythm notes 230 is changed at least once. In the case of changing the moving direction, the moving directions of all rhythm notes 230 existing on the screen are changed at the same time, whereby a user may feel as if the time lapses reversely. In one embodiment, the rhythm notes 230 appear on the side of the moving routes far from a user and move toward the user. In another embodiment, the rhythm notes 230 appear on the side of the moving routes close to a user and move away from the user. In this case, the hit reference positions 240 may be positioned on the side far from the user.

When the rhythm notes 230 reach the hit reference positions 240-1, 240-2 and 240-3 existing on the respective moving routes, a user touches the touch screen display corresponding to the hit reference positions 240-1, 240-2 and 240-3. The accuracy of a user input is determined based on a time difference between the timing at which the rhythm notes 230 reach the hit reference positions 240 existing on the moving routes and the timing at which the input is received from the user. The accuracy of a user input may be scored and displayed. In one embodiment, music corresponding to the timings of the rhythm notes 230 may be reproduced from the sound output unit 120. The determination method, the score acquisition method and the music reproduction method are the same as the conventional ones and are not the features of the present disclosure. Thus, the detailed description thereof will be omitted.

In the embodiment shown in FIG. 2, there is illustrated that three moving routes exist. However, the present disclosure is not limited thereto. Even if different rhythm notes 230 appear at the same point, the moving routes of the rhythm notes 230 may be different.

In the embodiment shown in FIG. 2, the moving routes 220-1, 220-2 and 220-3 are displayed on the screen. In another embodiment, the moving routes 220-1, 220-2 and 220-3 may not be displayed on the screen. In a further embodiment, after the rhythm notes appear on the virtual three-dimensional space 200, the moving routes of the rhythm notes may be displayed on the display.

The moving routes may be parallel to the axis 210 just like the moving routes 220-2 and 220-3. A part of the moving routes may not be parallel to the axis 210 just like the moving route 220-1.

The hit reference positions 240-1, 240-2 and 240-3 may be located at any position on the moving routes 220-1, 220-2 and 220-3. For example, the hit reference position 240-1 may be located closer to the user than the hit reference position 240-3. In another embodiment, the hit reference positions 240-1, 240-2 and 240-3 may be located at the same distance from the user.

In one embodiment, the virtual three-dimensional space 200 is rendered and displayed so that the virtual three-dimensional space 200 moves with respect to the image plane according to a predetermined method during at least a part of a time period during which a rhythm game is ongoing and so that the moving routes 220-1, 220-2 and 220-3 fixed in the virtual three-dimensional space 200 also move together with the movement of the virtual three-dimensional space 200. FIG. 4 shows a state after time has passed since the state in FIG. 2. In the embodiment shown in FIG. 2, the axis 210 of the three-dimensional space is substantially perpendicularly located at the center of the screen. Thereafter, the axis 210 makes a parallel movement. In FIG. 4, there is illustrated a state in which the axis 210 exists in an upper right portion of the screen and has a small inclination with respect to the image plane. After the rhythm note 230 on the moving route 220-3 is completely moved, the moving route 220-3 is not displayed as shown in FIG. 4.

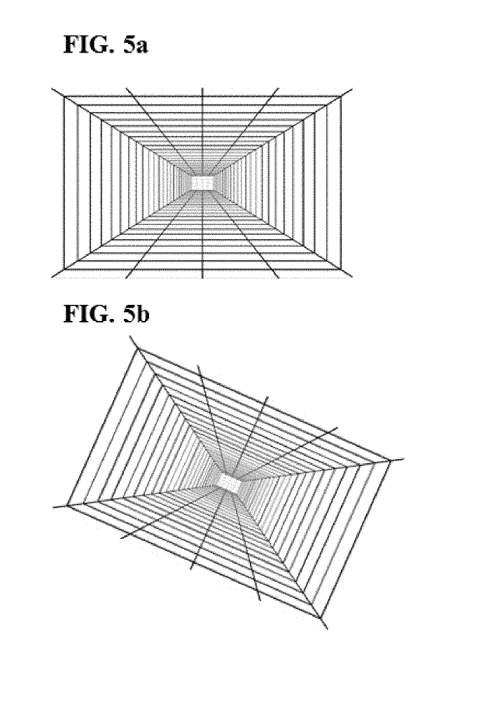

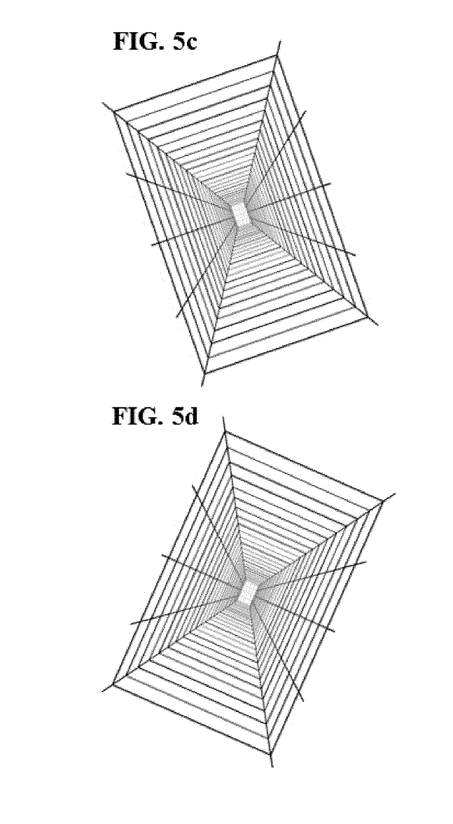

The movement of the three-dimensional space 200 is not limited to the present embodiment but may include a rotational movement about the axis 210. The rotational movement about the axis 210 includes a rotational movement about the axis 210 that does not make a parallel movement as shown in FIGS. 5A to 5D.

In addition, the movement of the three-dimensional space 200 may include a movement of the three-dimensional space 200 toward a specific end of the axis 210, a conical movement of a first end of the axis 210 about an arbitrary fixed point on the axis 210 performed so as to draw a circle or a circular arc, a movement of the first end of the axis 210 about an arbitrary fixed point on the axis 210 performed so as to draw an arbitrary shape, a movement of a user side end of the axis 210 from the inside of the image plane toward the outside of the image plane, a movement of the user side end of the axis 210 from the outside of the image plane toward the inside of the image plane, and a change of a shape of the axis 210. However, the movement of the three-dimensional space 200 is not limited thereto and may include a combination of two or more of the movements.

Among the movements illustrated above, the conical movement of a first end of the axis 210 about an arbitrary fixed point on the axis 210 performed so as to draw a circle includes a conical movement performed as shown in FIGS. 6A to 6D. In the example shown in FIGS. 6A to 6D, the user side end of the axis 210 exists outside the image plane. However, the conical movement may be similarly performed under a situation where the user side end of the axis 210 exists inside the image plane.

Among the movements illustrated above, the movement of a user side end of the axis 210 from the inside or outside of the image plane toward the outside or inside of the image plane includes, for example, a movement of a user side end of the axis 210 from the inside of the image plane (see FIG. 2) toward the outside of the image plane (see FIG. 3A) (or vice versa).

Among the movements illustrated above, the change of a shape of the axis 210 may include a change from a straight line (see FIG. 2) to a curved line (see FIG. 3B) (or vice versa). In another embodiment, the change of a shape of the axis 210 may include a change of a curvature radius of the axis 210 having a curved shape (not shown in the Figures).

As compared with the simple parallel movement or the simple rotational movement of the axis, such movements of the three-dimensional space 200 may enable a user to realistically feel a sense of cube of the three-dimensional space.

In addition, the movement of the three-dimensional space 200 may include a change of a size of the three-dimensional space 200. Examples of the change of a size of the three-dimensional space 200 include a change of a length of each side of a polygonal column which is the three-dimensional space 200 shown in FIG. 2, and a change of a radius of a cylinder shown in FIG. 3A. In one example, the size of the three-dimensional space 200 may be increased (or decreased) and then restored to an original state within a predetermined period of time. Moreover, a series of movements through which the size of the three-dimensional space is increased (or decreased) and then restored to an original state may be cyclically performed at predetermined time intervals.

Since the moving routes 220 are fixed in the virtual three-dimensional space 200, when the three-dimensional space 200 is moved as described above, the moving routes 220 are also moved together with the movement of the virtual three-dimensional space 200. In response, the rhythm notes 230 and the hit reference positions 240 are also moved together. In the embodiment in which the size of the virtual three-dimensional space 200 is changed, the positions of the moving routes 220 are moved in proportion to the change of the size of the three-dimensional space 200. For example, in the embodiment shown in FIG. 2, when the virtual three-dimensional space 200 grows larger, the moving routes 220-1 and 220-3 are moved away from each other. In one embodiment, the hit reference positions 240-1, 240-2 and 240-3 may be located in any position within the image plane along with the movement of the virtual three-dimensional space 200. Even if only one moving route 220-1 exists in the three-dimensional space 200, the hit reference position 240-1 may be continuously moved within the image plane along with the movement of the three-dimensional space 200. Such a feature may enable a user to enjoy the rhythm game while realistically feeling that the rhythm notes of the rhythm game are moving through the three-dimensional space.

According to another embodiment, the virtual three-dimensional space 200 may be moved in a state in which the moving routes 220 are not fixed to the virtual three-dimensional space 200. Such movement of the three-dimensional space 200 may include a change of a size of the three-dimensional space 200. Examples of the change of a size of the three-dimensional space 200 include a change of a length of each side of a polygonal column which is the three-dimensional space 200 shown in FIG. 2, or a change of a radius of a cylinder shown in FIG. 3A. In one example, the size of the three-dimensional space 200 may be increased (or decreased) and then restored to an original state within a predetermined period of time. For example, in the embodiment shown in FIG. 2, even if the virtual three-dimensional space 200 grows larger, the positions of the moving routes 220-1, 220-2 and 220-3 are not changed, and the distance between the moving route 220-1 and the moving route 220-3 is also not changed. Moreover, a series of movements through which the size of the three-dimensional space is increased (or decreased) and then restored to an original state may be cyclically performed at predetermined time intervals. In this regard, the predetermined period of time may be beats of music. In this case, the beats of music may be realistically expressed.

In one embodiment, the movement of the virtual three-dimensional space 200 in a state in which the moving routes 220 are not fixed to the virtual three-dimensional space 200 (hereinafter referred to as “first movement”) may be performed in an overlapping relationship with the movement of the moving routes 220 performed together with the movement of the virtual three-dimensional space 200 to which the moving routes 220 are fixed (hereinafter referred to as “second movement”). Description will be made by taking, as an example, a case where the first movement is a change of a size and the second movement is a conical movement of the axis 210. The virtual three-dimensional space 200 and the moving routes 220 make a conical movement along with the second movement. Even if the size of the virtual three-dimensional space 200 is increased along with the first movement together with such a conical movement, the first movement does not affect the positions of the moving routes 220. That is to say, the moving routes 220 are moved so as to follow the second movement and are not affected by the first movement.

According to one embodiment, the movement of the three-dimensional space 200 may be determined in advance. For example, the three-dimensional space 200 may be set so as to move in conformity with the beats of music. According to another embodiment, the movement of the virtual three-dimensional space may be dynamically determined according to the determination result of the step of determining the accuracy of a user input or the input from a user, which is described earlier. For example, when accurate user inputs are continuously performed, the three-dimensional space 200 may be rotated or the rotation of the three-dimensional space 200 may be accelerated. Alternatively, when a user touches a specific region of a screen, the axis of the three-dimensional space 200 may be moved so as to make a parallel movement or a conical movement in a direction corresponding to the specific region. Alternatively, when the user input is accurate or inaccurate, the three-dimensional space 200 may be caused to make a fine movement (e.g., a small rotation, a vibration, a change of a size, etc.). With such configuration, it is possible to give a user a sense of immersion.

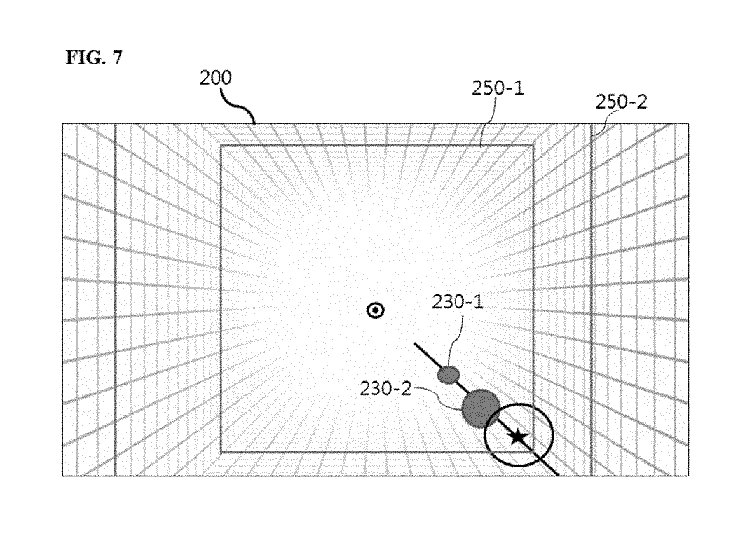

According to one embodiment, position indicators 250 for advising a user of the positions of the rhythm notes 230 in the virtual three-dimensional space 200 may be displayed on the side wall of the virtual three-dimensional space 200. Referring to FIG. 7, the position indicator 250-1 indicates the position of the rhythm note 230-1, and the position indicator 250-2 indicates the position of the rhythm note 230-2. In the present embodiment, the position indicators 250 are displayed as lines on the side wall of the virtual three-dimensional space 200. However, the present disclosure is not limited thereto.

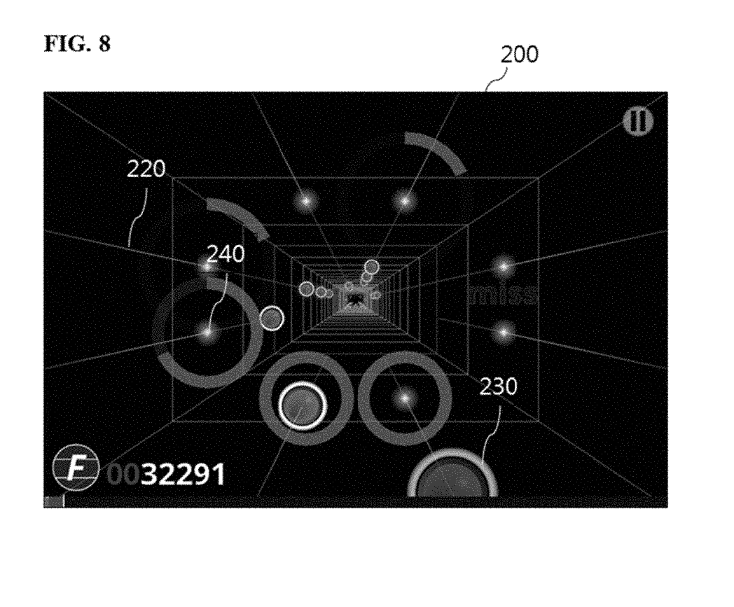

FIG. 8 shows one example of an actual game screen on which the rhythm game is realized. In the present embodiment, the position indicators 250 are not displayed. However, display of the position indicators 250 may be enabled in the settings of the rhythm game.

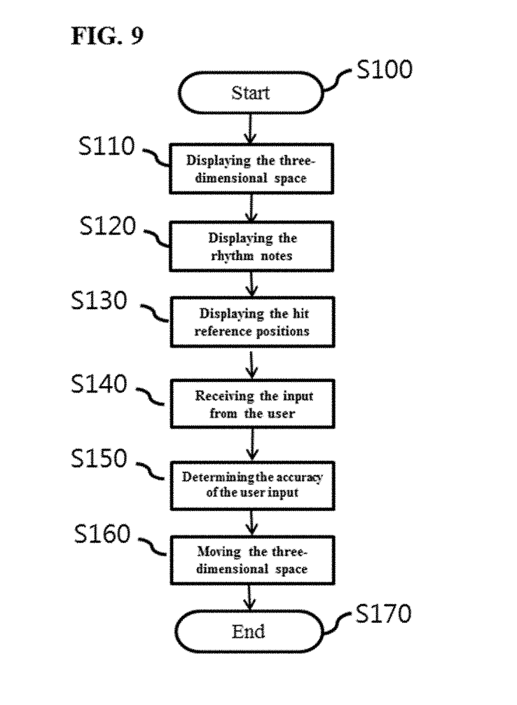

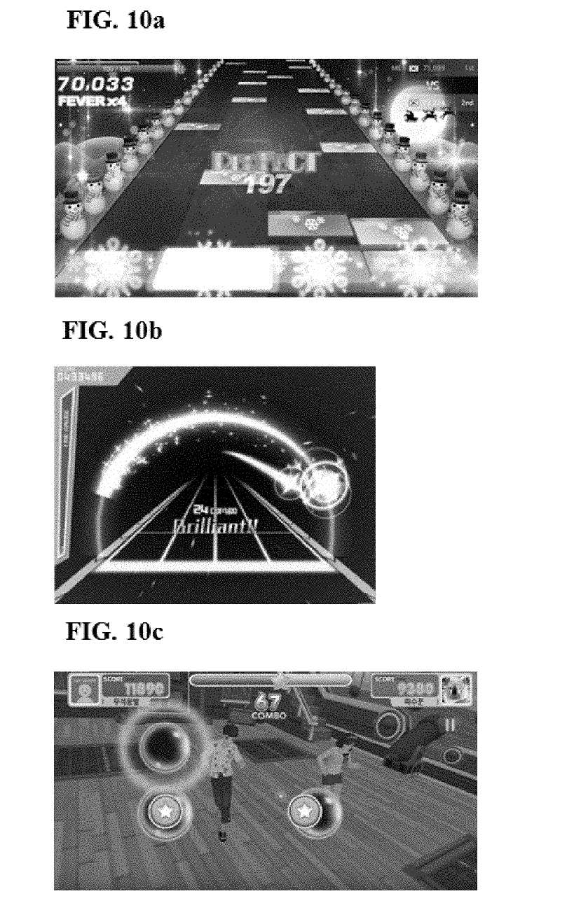

FIG. 9 is a flowchart showing a specific method of practicing the rhythm game. First, a virtual three-dimensional space 200 may be rendered and displayed on a display (step S110). Thereafter, one or more rhythm notes 230 having predetermined moving routes may be rendered within the virtual three-dimensional space 200 and may be displayed on the display (step S120). Hit reference positions 240 may be rendered and may be displayed on the display (step S130). Thereafter, an input may be received from a user at the positions on a touch screen corresponding to the hit reference positions 240 (step S140). Then, the accuracy of the user input may be determined based on a difference between a timing at which the rhythm notes 230 passes through the hit reference positions 240 and a timing at which the input is received from the user (step S150). In one embodiment, hereafter, the virtual three-dimensional space 200 may be moved according to the user input or the determination result (step S160). In another embodiment of step S160, the three-dimensional space 200 may be moved according to a predetermined method regardless of the user input and the determination result. The above steps do not have to be performed in the above-described order. It should be understood that the order may be changed and the steps may be combined.

The above-described exemplary methods according to the present disclosure may be realized in many different forms such as program commands to be executed by a processor, a software module, micro codes, a computer program product recoded on a recording medium readable by a computer (including all kinds of devices having an information processing function), an application, logic circuits, an application-specific integrated circuit, firmware, and the like. Examples of the computer-readable recording medium include a ROM, a RAM, a CD, a DVD, a magnetic tape, a hard disk, a floppy disk, an optical data storage device, and so forth. However, the computer-readable recording medium is not limited thereto. In addition, the computer-readable recording medium may be dispersed in computer systems connected via a network. Computer-readable codes may be stored and executed in a dispersed manner.

The foregoing description is nothing more than exemplary description of the present disclosure. A person having ordinary knowledge in the technical field to which the present disclosure pertains will be able to make various modifications without departing from the technical idea of the present disclosure.

Accordingly, the embodiments disclosed herein are not intended to limit the present disclosure. The scope of the present disclosure should be construed based on the appended claims. All kinds of techniques falling within a scope equivalent to the claims should be construed to be included in the scope of the present disclosure.

What is claimed is:

1. A method for displaying a rhythm game performed by a terminal including a touch screen display, comprising:
rendering and displaying a virtual three-dimensional space on the touch screen display, the virtual three-dimensional space provided with an axis making an angle of 0 degree or more with respect to an image plane of the touch screen display and positioned in a first space opposite to a user with respect to the image plane;
rendering one or more rhythm notes having predetermined moving routes at least partially parallel to the axis in the virtual three-dimensional space and displaying the rhythm notes on the touch screen display, wherein each of the rhythm notes configured to appear at one end of each of the moving routes, move along each of the moving routes and pass through each of hit reference positions existing on the moving routes;
rendering the hit reference positions and displaying the hit reference positions on the touch screen display;
receiving an input from the user at positions on the touch screen display corresponding to the hit reference positions; and
determining the accuracy of a user input based on a difference between a timing at which a rhythm note passes through a hit reference position and the timing at which the input is received from the user,
wherein the moving routes are fixed in the virtual three-dimensional space,
the virtual three-dimensional space is rendered so that the virtual three-dimensional space moves with respect to the image plane according to a predetermined method during at least a part of a time period when the rhythm game is ongoing and so that the moving routes fixed in the virtual three-dimensional space also move together with the movement of the virtual three-dimensional space, and the hit reference positions are located at any position within a range in which the virtual three-dimensional space is displayed.

2. The method of claim 1, further comprising:
rendering the predetermined moving routes and displaying the predetermined moving routes on the touch screen display.

3. The method of claim 2, further comprising:
displaying the predetermined moving routes on the touch screen display after the rhythm notes appear in the first space.

4. The method of claim 1, wherein the axis is substantially perpendicular to the image plane.

5. The method of claim 1, wherein the axis is a straight line or a curved line.

6. The method of claim 1, wherein the axis has a shape which changes over time.

7. The method of claim 1, wherein the virtual three-dimensional space has a cylindrical or polygonal columnar shape,
the axis corresponds to a center axis of the cylinder or the polygonal column shape, and
the rendering and displaying the virtual three-dimensional space on the touch screen display includes displaying at least a part of a side wall of the virtual three-dimensional space on the touch screen display.

8. The method of claim 1, wherein the movement of the virtual three-dimensional space with respect to the image plane according to the predetermined method includes a rotational movement of the virtual three-dimensional space about the axis or a parallel movement of the axis.

9. The method of claim 1, wherein the movement of the virtual three-dimensional space with respect to the image plane according to the predetermined method includes at least one of a movement of the virtual three-dimensional space toward a specific end of the axis, a conical movement of a first end of the axis about an arbitrary fixed point on the axis performed so as to draw a circle, a movement of a user side end of the axis from the inside of the image plane toward the outside of the image plane, a movement of the user side end of the axis from the outside of the image plane toward the inside of the image plane, a change of a shape of the axis, and a change of a size of the virtual three-dimensional space.

10. The method of claim 1, wherein the rhythm notes are configured to change movement directions thereof at least once when moving along the moving routes.

11. The method of claim 1, wherein the axis has a first end oriented toward the user and a second end oriented toward the first space.

12. The method of claim 1, wherein the movement of the virtual three-dimensional space is determined based on the determination result obtained in the determining the accuracy of the user input or the input received from the user, and the virtual three-dimensional space moves according to the movement of the virtual three-dimensional space thus determined.

13. The method of claim 1, further comprising:
displaying position indicators, which advise the user of positions of the rhythm notes in the virtual three-dimensional space, on the virtual three-dimensional space.

14. The method of claim 7, wherein the side wall displayed on the touch screen display is rendered so that, during a part of a time period when the rhythm game is ongoing, the side wall is moved according to a predetermined method in a state in which the moving routes are not fixed in the virtual three-dimensional space.

15. The method of claim 14, wherein the movement of the side wall according to the predetermined method in a state in which the moving routes are not fixed in the virtual three-dimensional space includes a change of a size of the virtual three-dimensional space.

16. A method for displaying a rhythm game performed by a terminal including a touch screen display, comprising:
rendering and displaying a virtual three-dimensional space on the touch screen display, the virtual three-dimensional space provided with an axis making an angle of 0 degree or more with respect to an image plane of the touch screen display and positioned in a first space opposite to a user with respect to the image plane;
rendering one or more rhythm notes having predetermined moving routes at least partially parallel to the axis in the virtual three-dimensional space and displaying the rhythm notes on the touch screen display, wherein each of the rhythm notes is configured to appear at one end of each of the moving routes, move along each of the moving routes and pass through each of hit reference positions existing on the moving routes, the moving routes fixed in the virtual three-dimensional space;
rendering the hit reference positions and displaying the hit reference positions on the touch screen display;
receiving an input from the user at positions on the touch screen display corresponding to the hit reference positions;
determining the accuracy of a user input based on a difference between a timing at which a rhythm note passes through a hit reference position and the timing at which the input is received from the user; and
rendering the virtual three-dimensional space so that the virtual three-dimensional space moves with respect to the image plane based on the determination result obtained in the determining the accuracy of the user input or the input received from the user and so that the moving routes fixed in the virtual three-dimensional space also move together with the movement of the virtual three-dimensional space,
wherein the hit reference positions are located at any position within a range in which the virtual three-dimensional space is displayed.

17. The method of claim 16, wherein the virtual three-dimensional space is rendered so that the virtual three-dimensional space further moves with respect to the image plane according to a predetermined method during at least a part of a time period when the rhythm game is ongoing and so that the moving routes fixed in the virtual three-dimensional space also move together with the movement of the virtual three-dimensional space.

18. The method of claim 16, wherein a side wall of the virtual three-dimensional space displayed on the touch screen display is rendered so that, during a part of a time period when the rhythm game is ongoing, the side wall moves according to a predetermined method in a state in which the moving routes are not fixed in the virtual three-dimensional space.

19. The method of claim 18, wherein the movement of the side wall according to the predetermined method in a state in which the moving routes are not fixed in the virtual three-dimensional space includes a change of a size of the virtual three-dimensional space.

20. A computer-readable recording medium which stores a computer program configured to execute the method of claim 1.
